(19) United States
(12) Patent Application Publication
(10) Pub. No.: US 2024/0005001 A1
(43) Pub. Date: Jan. 4, 2024

(54) SYSTEM AND METHOD FOR COMBINING CYBER-SECURITY THREAT DETECTIONS

(71) Applicant: CITRIX SYSTEMS, INC., Ft. Lauderdale, FL (US)

(72) Inventors: Andreas Varnavas, Achaia (GR); Georgios Papaloukopoulos, Achaia (GR); Asterios Stergioudis, Chalkidiki (GR); Dimitrios Markonis, Attica (GR); Nikolaos Tsapakis, Messinia (GR); Georgios Tsolis, Achaia (GR)

(73) Assignee: Citrix Systems, Inc., Ft. Lauderdale, FL (US)

(21) Appl. No.: 17/868,378

(22) Filed: Jul. 19, 2022

Related U.S. Application Data
(63) Continuation of application No. PCT/GR22/00033, filed on Jun. 30, 2022.

(51) Int. Cl. G06F 21/56; G06N 7/00

(52) U.S. Cl. CPC G06F 21/566; G06N 7/005

(57) ABSTRACT

A computer system is provided. The computer system includes a memory and at least one processor coupled to the memory and configured to detect triggering of one or more threat detectors. The at least one processor is further configured to activate a subset of nodes from a plurality of nodes in a Bayesian network in response to the detection, the activated subset of nodes associated with the triggered threat detectors. The at least one processor is further configured to calculate a probability of malicious action using the Bayesian network to combine probabilities associated with the activated subset of nodes. The at least one processor is further configured to determine that the probability exceeds a threshold value. The at least one processor is further configured to perform a security action in response to the determination.

### CROSS-REFERENCE TO RELATED APPLICATION

This application claims priority under 35 U.S.C. § 120 as a continuation of PCT Application No. PCT/GR2022/000033, titled “SYSTEM AND METHOD FOR COMBINING CYBER-SECURITY THREAT DETECTIONS” and filed Jun. 30, 2022, which is hereby incorporated herein by reference in its entirety.

### BACKGROUND

Cybersecurity is an issue of great importance, as attacks on computer systems and the users of those systems continue to increase. There are many types of cyberattacks and threats, which can employ any of a large variety of different techniques. Existing security monitoring tools often struggle to cope with the large and increasing number of threats. Threat detection is a complex and difficult task which can result in either a high false alarm rate or a poor detection rate.

### SUMMARY

In at least one example, a computer system is provided. The computer system includes a memory; and at least one processor coupled to the memory and configured to: detect triggering of one or more threat detectors; activate a subset of nodes from a plurality of nodes in a Bayesian network in response to the detection, the activated subset of nodes associated with the triggered threat detectors; calculate a probability of malicious action using the Bayesian network to combine probabilities associated with the activated subset of nodes; determine that the probability exceeds a threshold value; and perform a security action in response to the determination.

At least some examples of the computer system can include one or more of the following features. Each node of the plurality of nodes of the Bayesian network is configured to provide a probability of detection and a probability of false alarm of the threat associated with the each node. The each node is associated with a threat objective and with one or more threat techniques, the threat techniques associated with the threat objective and with one of the threat detectors. The Bayesian network includes a node associated with a user property detector, the user property detector configured to detect properties of the user associated with malicious action, and the at least one processor is further configured to calculate a probability of malicious action using the Bayesian network to combine probabilities associated with the activated subset of nodes and the node associated with the user property detector. The properties include a geolocation of the user and reputation data associated with an internet provider employed by the user. The at least one processor is further configured to select the threshold value based on a tradeoff between a probability of detection of the malicious action and a probability of false alarm of the malicious action. The at least one processor is further configured to create and update the plurality of nodes of the Bayesian network based on provisioning of threat detectors and provisioning of threat detector performance data.

In at least one example, a method for combining threat detections is provided. The method includes: detecting, by a computer system, triggering of one or more threat detectors; activating, by the computer system, a subset of nodes from a plurality of nodes in a Bayesian network in response to the detection, the activated subset of nodes associated with the triggered threat detectors; calculating, by the computer system, a probability of malicious action using the Bayesian network to combine probabilities associated with the activated subset of nodes; determining, by the computer system, that the probability exceeds a threshold value; and performing, by the computer system, a security action in response to the determination.

At least some examples of the method can include one or more of the following features. Each node of the plurality of nodes of the Bayesian network is configured to provide a probability of detection and a probability of false alarm of the threat associated with the each node. The each node is associated with a threat objective and with one or more threat techniques, the threat techniques associated with the threat objective and with one of the threat detectors. The Bayesian network includes a node associated with a user property detector, the user property detector is configured to detect properties of the user associated with malicious action, and the method further comprises calculating a probability of malicious action using the Bayesian network to combine probabilities associated with the activated subset of nodes and the node associated with the user property detector. The properties include a geolocation of the user and reputation data associated with an internet provider employed by the user. The method further comprises selecting the threshold value based on a tradeoff between a probability of detection of the malicious action and a probability of false alarm of the malicious action. The method further comprises creating and updating the plurality of nodes of the Bayesian network based on provisioning of threat detectors and provisioning of threat detector performance data.

In at least one example a non-transitory computer readable medium storing executable sequences of instructions to combine threat detections, the sequences of instructions comprising instructions to: detect triggering of one or more threat detectors; activate a subset of nodes from a plurality of nodes in a Bayesian network in response to the detection, the activated subset of nodes associated with the triggered threat detectors; calculate a probability of malicious action using the Bayesian network to combine probabilities associated with the activated subset of nodes; determine that the probability exceeds a threshold value; and perform a security action in response to the determination.

At least some examples of the non-transitory computer readable medium can include one or more of the following features. Each node of the plurality of nodes of the Bayesian network is configured to provide a probability of detection and a probability of false alarm of the threat associated with the each node. The each node is associated with a threat objective and with one or more threat techniques, the threat techniques associated with the threat objective and with one of the threat detectors. The Bayesian network includes a node associated with a user property detector, the user property detector configured to detect properties of the user associated with malicious action, and the sequences of instructions further include instructions to calculate a probability of malicious action using the Bayesian network to combine probabilities associated with the activated subset of nodes and the node associated with the user property detector. The properties include a geolocation of the user and reputation data associated with an internet provider employed by the user. The sequences of instructions further include instructions to select the threshold value based on a tradeoff between a probability of detection of the malicious action and a probability of false alarm of the malicious action. The sequences of instructions further include instructions to create and update the plurality of nodes of the Bayesian network based on provisioning of threat detectors and provisioning of threat detector performance data.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of an implementation of a system for integrating threat detections, in accordance with an example of the present disclosure.

FIG. 2 is a block diagram of the threat detector integration system, in accordance with an example of the present disclosure.

FIG. 3 is a block diagram of an integrated threat detector, in accordance with an example of the present disclosure.

FIG. 4 is a block diagram of a model generator, in accordance with an example of the present disclosure.

FIG. 5 is a flow diagram of a process for integrating threat detections, in accordance with an example of the present disclosure.

FIG. 6 is a flow diagram of a process for instantiating a Bayesian network architecture, in accordance with an example of the present disclosure.

FIG. 7 is a flow diagram of a process for calculating conditional probabilities, in accordance with an example of the present disclosure.

FIG. 8 is a flow diagram of a process for calculating detection thresholds, in accordance with an example of the present disclosure.

FIG. 9 is a diagram of a Bayesian network architecture, in accordance with an example of the present disclosure.

FIG. 10 is a diagram of a technique detector graph (TDG) model, in accordance with an example of the present disclosure.

FIG. 11 is a diagram of another TDG model, in accordance with an example of the present disclosure.

FIG. 12 is a diagram of yet another TDG model, in accordance with an example of the present disclosure.

FIG. 13 illustrates conditional probability tables (CPTs), in accordance with an example of the present disclosure.

FIG. 14 illustrates a receiver operating curve (ROC), in accordance with an example of the present disclosure.

FIG. 15 is a block diagram of a computing platform configured to perform threat detector integration, in accordance with an example of the present disclosure.

### DETAILED DESCRIPTION

As noted previously, cybersecurity is an issue of great importance and monitoring of the many different types of attacks is a difficult and complex task, with existing threat techniques numbering in the thousands or more and growing daily. Threat detectors exist for many types of attack techniques, though not all. Systems that rely solely on existing threat detectors suffer from at least two weaknesses. First, they typically generate many false alarms which can result in alert fatigue for users and administrators which may then allow actual threats to go unchallenged. Second, new attack techniques are constantly being introduced which, having not yet been modelled, can go undetected.

To address these and other problems, and as summarized above, various examples described herein are directed to systems and methods to integrate cyber-security threat detections by collecting the detections, generated over a period of time and based on activity from a relatively large number of users and devices, and probabilistically combining those detections using a Bayesian network model. The Bayesian network model is configured to jointly assess a wide range of factors including: (1) signals from threat detectors related to user actions and/or unusual behaviors; (2) threat intelligence (e.g., metadata) about the users and the internet providers (IP) that they are using; and (3) expert knowledge about the structure of an attack and the dependencies between the stages of that structure. The disclosed techniques employ the Bayesian network model to combine this information to generate a score that can be used to identify potential threats. In some examples, the score can be compared to one or more thresholds to make decisions about the potential threats and actions to be taken based on a tradeoff between probability of detection and probability of false alarm.

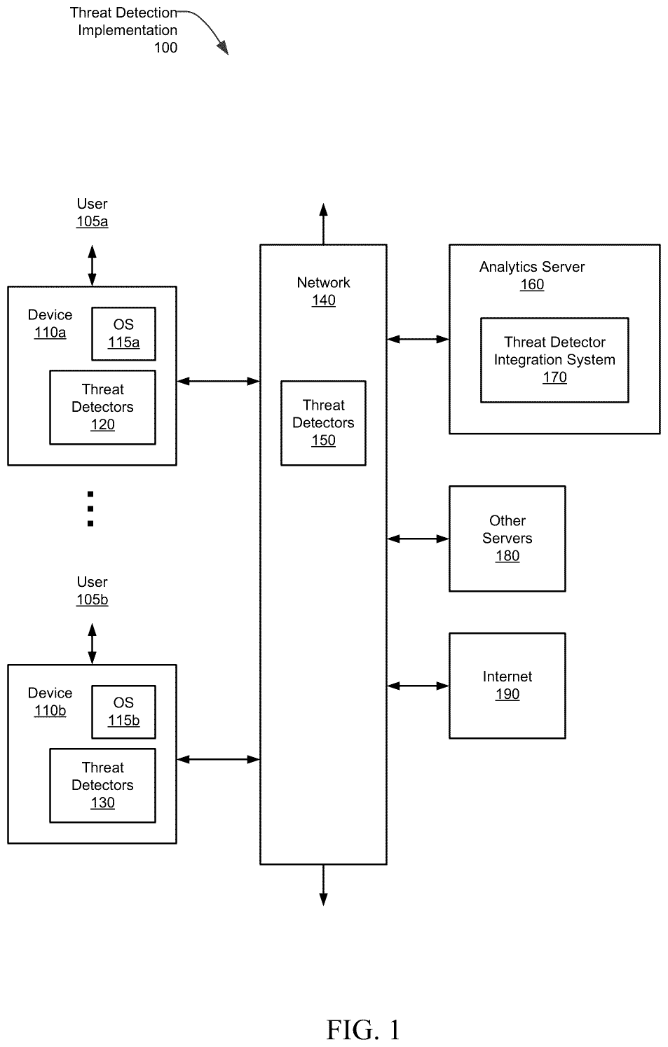

FIG. 1 is a top-level block diagram of an implementation of a system 100 for integrating threat detections, in accordance with an example of the present disclosure. The system 100 is shown to include a number of users 105, a network 140, and an analytics server 160. In some examples the network 140 may also connect to other servers 180 and the Internet 190. Each user 105 is operating a device 110 which may be a laptop, tablet, smartphone, workstation, or any other suitable computing or communication device. The device 110 may include an operating system (OS) 115 and one or more threat detectors 120. The threat detectors 120 may be integrated into the OS 115 and/or they may be applications installed on the device.

The network 140 is configured to connect the devices to the analytics server 160, the other servers 180, and the Internet 190. In some examples, the infrastructure of the network 140 may include additional threat detectors 150 configured to monitor and detect threats in the network traffic.

The analytics server 160 is shown to include a threat detector integration system 170. The operation of the threat detector integration system will be described in greater detail below, but at a high level, the system 170 is configured to combine threat detections, provided by the various detectors, with threat intelligence associated with the users and their IPs, along with expert knowledge about the techniques used to carry out the threats. The combination is performed in a probabilistic manner using a Bayesian network model. In some examples, the analytics server 160 may be any suitable type of server.

In some examples, the disclosed techniques provide a way to efficiently combine and manage a large quantity of data that may be generated by many threat detectors and many users over a period of time without increasing the false alarm rate or suppressing alerts which would decrease the benefit of employing more detectors. These systems and methods allow for the productive utilization of a large number and variety of detectors configured to catch a wide range of unusual behaviors and suspicious actions of the users.

As will be understood in view of this disclosure, the systems and methods for threat detector integration provided herein have advantages over existing methods which treat each detector alert as an individual event, simply counting the number of occurrences while ignoring the probabilistic nature of the problem. For instance, the systems and methods described herein provide for combining detector results based on the characteristics of each detector and knowledge of how attacks are executed.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

### Threat Detector Integration System

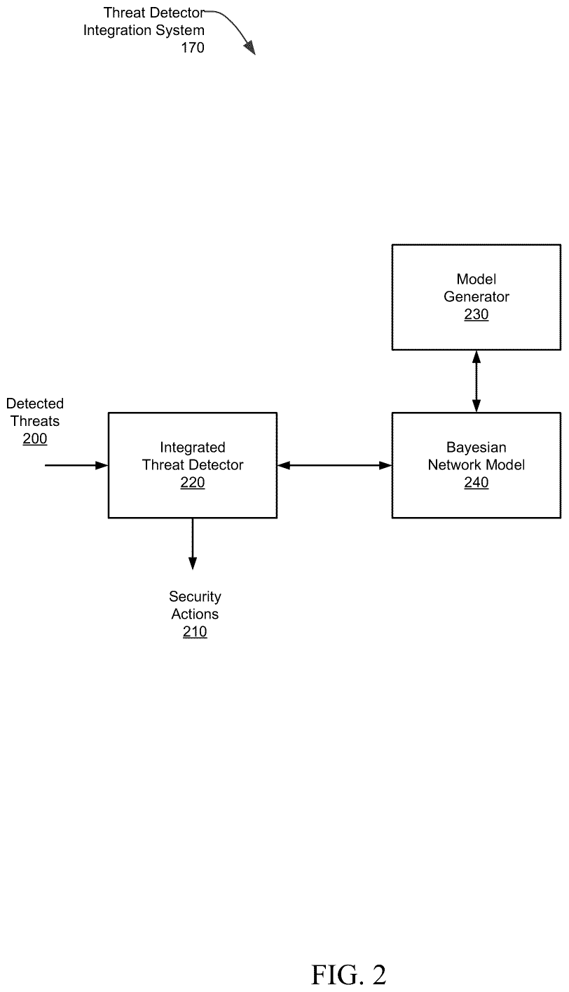

FIG. 2 is a block diagram of the threat detector integration system 170, in accordance with an example of the present disclosure. The system 170 is shown to include an integrated threat detector 220, a Bayesian network model generator 230, and the Bayesian network model 240.

The operation of the integrated threat detector 220 is described in greater detail below, but at a high level it is configured to collect threat detections 200 and use the Bayesian network model 240 to calculate a probability of maliciousness (also referred to as a score) for determination of the existence and severity of a possible threat. In some examples, security actions 210 may be performed in response to the determination.

The operation of the Bayesian network model generator 230 is also described in greater detail below, but at a high level it is configured to create and update the Bayesian network model 240 based on information about the detector characteristics, expert knowledge about the threat objectives and techniques, dependencies between the threats and techniques, and other relevant data.

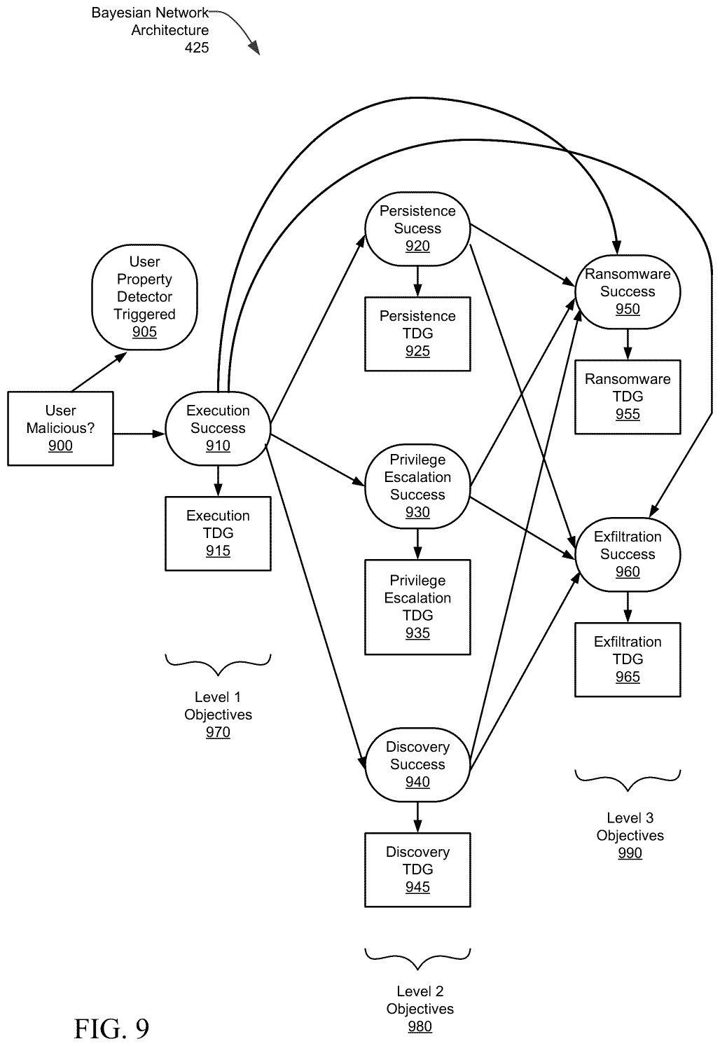

The Bayesian network model 240 is configured to store the probabilistic information associated with the user and the known threats in the form of a network (e.g., a graph of connected nodes) that allows for efficient calculation of the probability of malicious action based on probabilities, conditional probabilities and interdependencies of the nodes. One example of a Bayesian network architecture is illustrated in FIG. 9 and will be described in greater detail below.

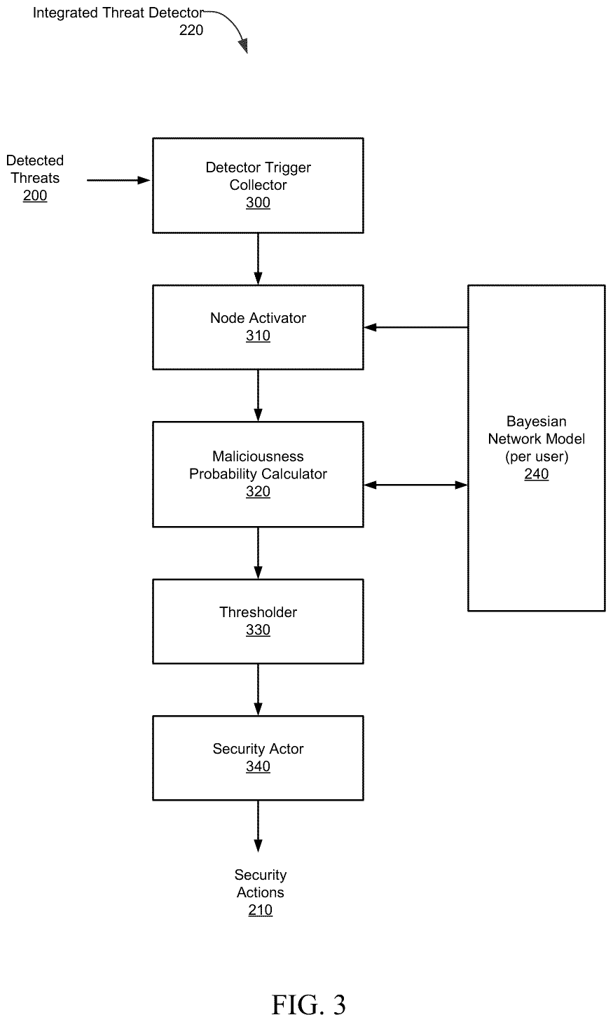

FIG. 3 is a block diagram of the integrated threat detector 220, in accordance with an example of the present disclosure. The integrated threat detector 220 is shown to include a detector trigger collector 300, a node activator 310, a maliciousness probability calculator 320, a thresholder 330, and a security actor 340.

The detector trigger collector 300 is configured to detect the triggering 200 of one or more threat detectors, from user devices, the network, or any other source where a threat detector may be employed. For example, threat detectors may communicate detected threats as messages transmitted over the network or through an application programming interface (API). The node activator 310 is configured to activate nodes in the Bayesian network in based on the triggered detectors. The nodes to be activated are associated with the threats corresponding to the triggered detectors.

The maliciousness probability calculator 320 is configured to calculate a probability of malicious action (e.g., a score) using the Bayesian network to combine probabilities associated with the activated nodes. In some examples, the calculation may be performed using pyAgrum, or other suitable techniques in light of the present disclosure.

The thresholder 330 is configured to determine that the score exceeds a selected threshold value to indicate that a malicious threat has been detected. In some examples, the thresholder 330 may determine that the score lies within one or more ranges delimited by a plurality of threshold values, where each range is associated with different levels of confidence that a malicious threat has been detected.

The security actor 340 is configured to perform one or more security actions 210 based on the determination of the thresholder 330. Security actions may include, for example, notifying the user or an administrator, logging the event, and/or taking actions to prevent the malicious threat from achieving a threat objective or causing additional damage.

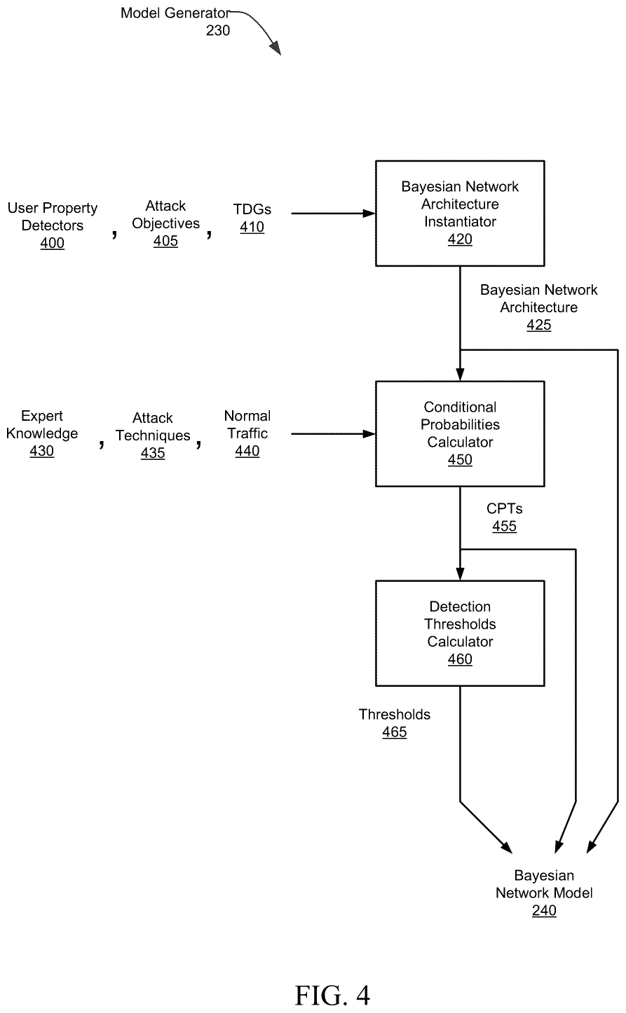

FIG. 4 is a block diagram of the Bayesian network model generator 230, in accordance with an example of the present disclosure. The model generator 230 is configured to create and update the Bayesian network model 240, as information about users and threats becomes available or changes. The model generator 230 is shown to include a Bayesian network architecture instantiator 420, a CPT calculator 450, and a detection thresholds calculator 460.

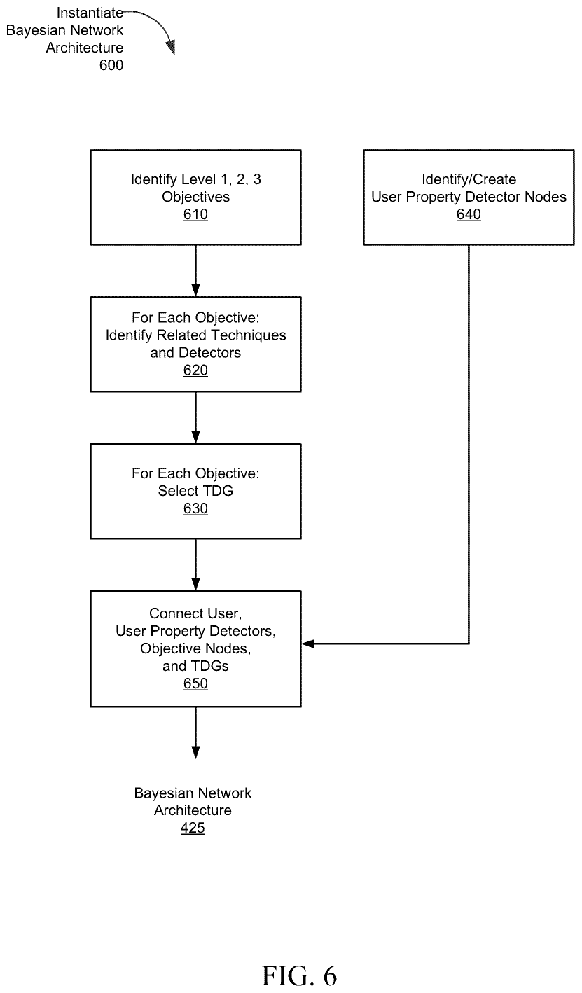

The Bayesian network architecture instantiator 420 is configured to create and update the network architecture 425, one example of which is illustrated in FIG. 9. The instantiator operates based on user property detectors 400, attack objectives 405, and TDGs 410. The network architecture 425 describes the cybersecurity related properties and activities of users in the environment. Operation of the instantiator 420 and the inputs 400, 405, 410, is described below in connection with FIG. 6.

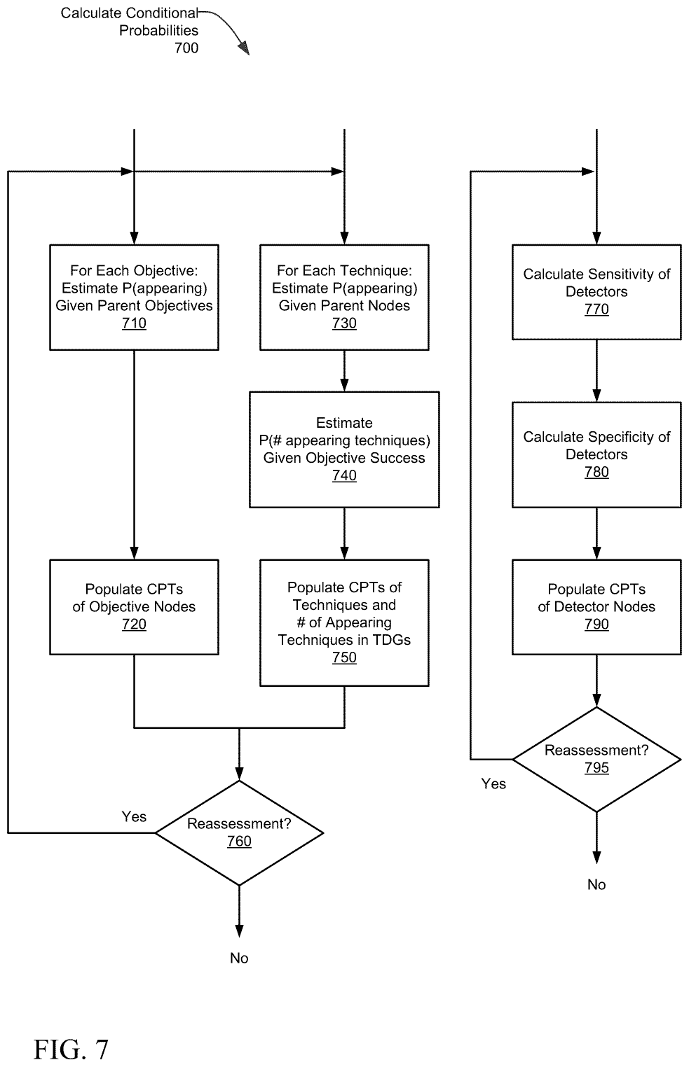

The CPT calculator 450 is configured to generate the conditional probability tables 455 that are associated with each node in the network, based on expert knowledge 430, attack techniques 435, and normal traffic patterns 440. Operation of the CPT calculator 450 and associated inputs is described below in connection with FIG. 7.

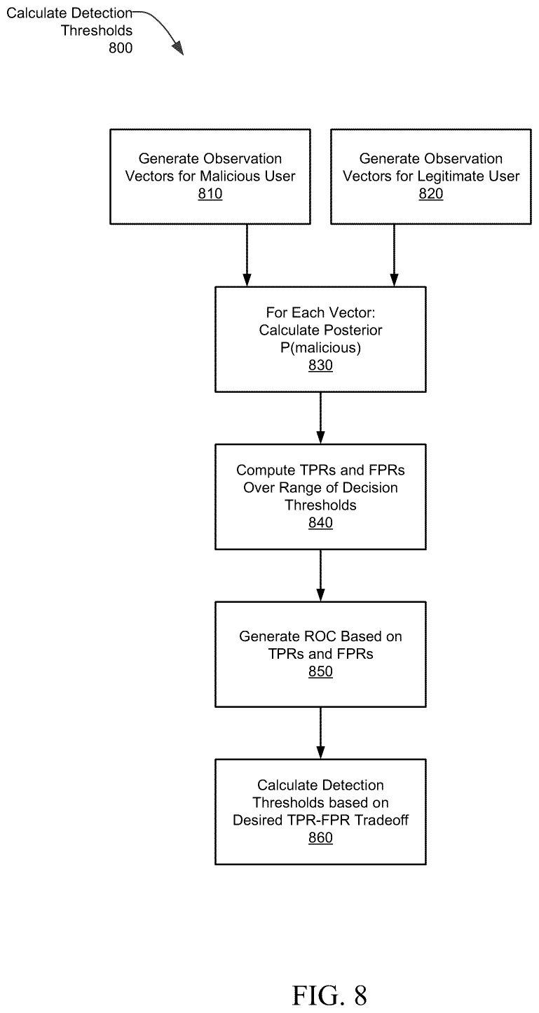

The detection thresholds calculator 460 is configured to calculate threshold values 465 for use by the integrated threat detector 220, to generate alerts and categorize users and/or events into different risk levels. Operation of the detection thresholds calculator 460 is described below in connection with FIG. 8. The Bayesian network model 240 comprises the architecture 425, CPTs 455, and thresholds 465.

### Threat Detector Integration Process

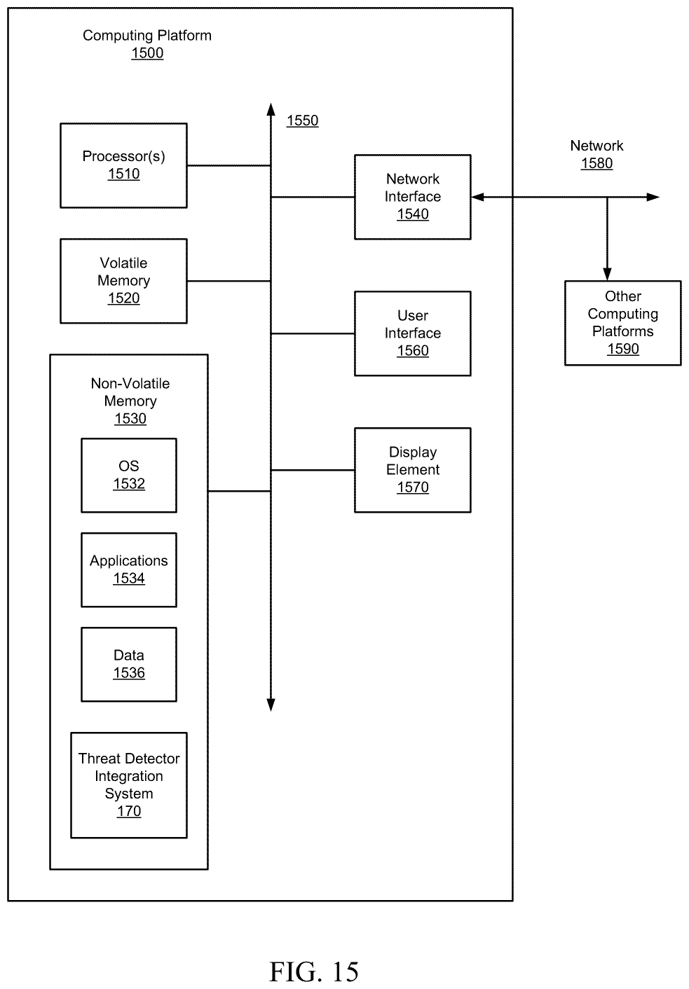

As described above, some examples of the implementation 100 of FIG. 1 are configured to perform a process for threat detector integration. The processes may be executed on a processor of any suitable type (e.g., processor 1510 of FIG. 15).

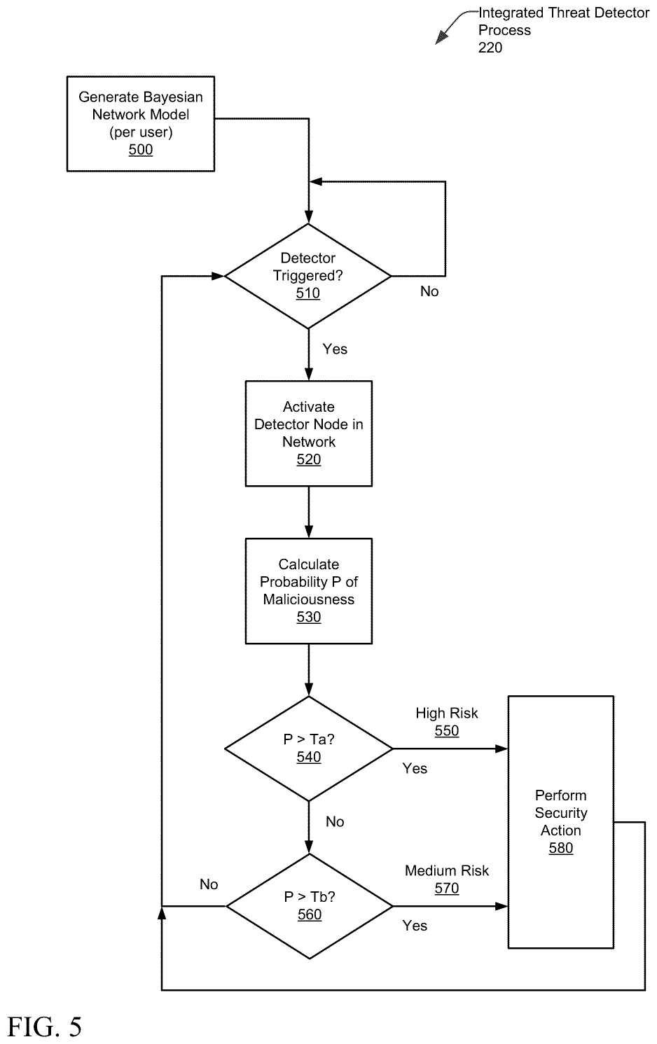

FIG. 5 is a flow diagram of a process for integrating threat detections, executed by the integrated threat detector 220, or the sub-components thereof, in accordance with an example of the present disclosure.

At operation 500, a Bayesian network model, is generated for each user 105. The network generation process is described below in connection with FIGS. 6-8.

Next, at operation 510, the process loops until a threat detector is triggered.

At operation 520, nodes in the network model 240 which are associated with the triggered detectors are activated.

At operation 530, the probability of maliciousness is calculated using the Bayesian network model 240 to combine probabilities associated with the activated nodes. In some examples, the calculation may be performed using pyAgrum, or other suitable techniques in light of the present disclosure.

At operation 540, the calculated probability is compared to a first threshold value, threshold A (Ta), and if the threshold is exceeded then a relatively high risk 550 is determined to exist.

At operation 560, the calculated probability is compared to a second threshold value, threshold B (Tb), and if that threshold is exceeded then a relatively medium risk 570 is determined to exist. Otherwise, the risk is determined to be relatively low, and the process continues to loop back to operation 510. In some examples, additional thresholds may be used to further categorize different levels of risk. In some examples, the threshold values are selected based on a tradeoff between probability of detection and probability of false alarm. In some examples, the selection may be provided by an IT administrator (or other personnel tasked with making risk assessment and risk tolerance decisions) through a user interface (UI) of the analytics server 160.

At operation 580, for the case of high risk or medium risk, an appropriate security action (tailored to the respective risk level) is performed and then the process continues to loop back to operation 510. In some examples, security actions may include one or more of notifying the user or an administrator, logging the event, and/or taking actions to prevent the malicious threat from achieving a threat objective or causing additional damage.

In some examples, the process for integrating threat detections operates over a rolling time window (e.g., a day, a week, etc.) during which threat detectors are monitored and nodes in the network are activated and remain activated for the duration of the time window.

FIG. 6 is a flow diagram of a process for instantiating the Bayesian network architecture, executed by the Bayesian network architecture instantiator 420, or the sub-components thereof, in accordance with an example of the present disclosure.

The process will be described with reference to the diagram, shown in FIG. 9, of a Bayesian network architecture 425, in accordance with an example of the present disclosure. The Bayesian network describes the cybersecurity related activity of a user on a computing environment (e.g., an information technology or IT environment). The network architecture is shown to include a number of nodes.

The user node 900 is associated with a binary random variable that presents the question of whether the user is malicious. The inference about the value of this variable drives the alert generation in the integrated threat detector 220.

The user property detector node 905 is associated with a binary random variable indicating whether a user property based detector is triggered. User property based detectors are configured to decide user maliciousness based on properties of the user such as an unusual or unexpected geolocation or probabilistic threat intelligence such as reputation data of the user's IP (e.g., the user's IP is known to be associated with malicious activity). User property detectors are conditionally independent to the other nodes in the Bayesian network, which is to say that knowledge about the maliciousness of the user is not related to other objectives or activities described by the remaining network nodes.

The remaining circular shaped nodes of FIG. 9 are objective nodes. These nodes are associated with a potential objective of a malicious user. Each of the objective nodes corresponds to a binary random variable associated with the question of whether that objective has been achieved by the user in the environment. The objectives fall into one of three categories: level 1 objectives 970, level 2 objectives 980, and Level 3 objectives 990.

Level 1 objectives 970 include those objectives which are necessary to be achieved as a first step so that a malicious actor can proceed with a higher level objective. Execution success 910, which is running code for a malicious purpose, is the primary level 1 objective in this example.

Level 2 objectives 980 include intermediate objectives which may or may not be achieved by a malicious actor prior to achieving an end goal objective (e.g., a Level 3 objective). Level 2 objectives include persistence success 920 (e.g., establishing a long term presence on a network), privilege escalation success 930, and discovery success 940 (e.g., monitoring and probing), in this example. As the connections in the Bayesian network indicate, Level 2 objectives are modeled to be conditionally independent to each other, given the level 1 Execution objective.

Level 3 objectives 990 are the end goal objectives which may include ransomware success 950 and data exfiltration success 960 (e.g., data theft). Level 3 objectives are connected in the Bayesian Network with Level 1 and Level 2 objectives, indicating that the probability of their appearance in the environment is conditioned on the appearance of the objectives in the previous levels. In some examples, additional objectives may be included.

Additionally, as shown in FIG. 9, each of the objective nodes is associated with a TDG (execution TDG 915, persistence TDG 925, privilege escalation TDG 935, discovery TDG 945, ransomware TDG 955, and exfiltration TDG 965). A TDG is a subgraph which is connected to each objective and includes nodes for the techniques that a malicious actor may use to achieve the objective, and nodes for the detectors of each such technique. These detector nodes (as well as the property nodes) are the nodes in the Bayesian Network which are activated. Depending on the dependencies between the techniques, one of three types of subgraphs may be used, as described below.

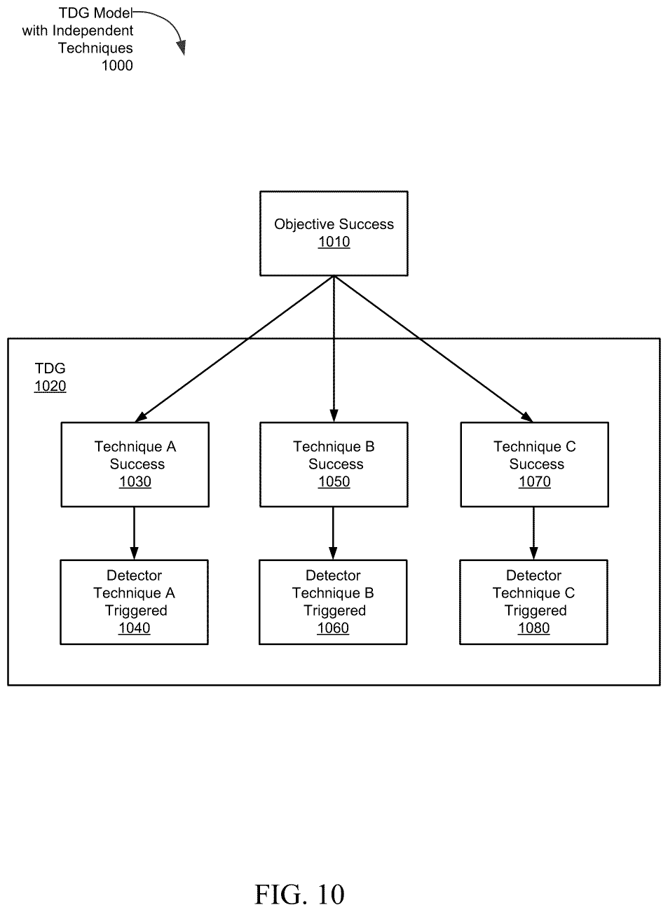

For the case of independent techniques, the TDG model 1000, illustrated in FIG. 10, may be used. Here, the TDG subgraph 1020 models the techniques 1030, 1050, and 1070 to be conditionally independent to each other. The probability of each technique (conditioned on the success of the objective 1010) may be provided by expert knowledge (e.g., specified by a security expert), separately for each technique. This model can be used for cases when the appearance of one technique in the environment (e.g., a triggering of technique detector 1040, 1060, or 1080), given the success of the objective 1010, does not provide additional information about the appearance of the other techniques. For example, techniques associated with the discovery objective 940, can be modelled in this way as there are multiple things to be discovered in the environment, so it is reasonable to model the appearance of one discovery technique as not influencing the appearance of another discovery technique.

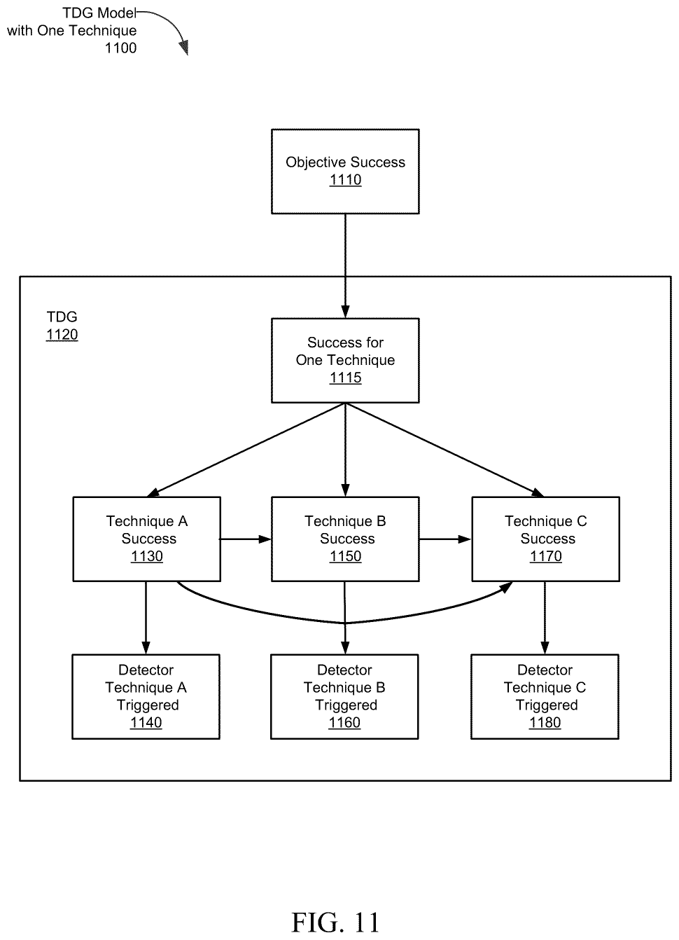

For the case where only one technique (or no techniques) can appear, the TDG model 1100, illustrated in FIG. 11, may be used to model the probability of success for the one technique 1115. This is useful for cases where there is no reason to have more than one technique appearing in the environment simultaneously. For example, techniques associated with the privilege escalation objective 930, can be modelled in this way as once the malicious actor has succeeded in escalating their privileges with one technique, there is no reason to try a different technique. Similarly, techniques associated with the ransomware objective 950 can be modelled in this way. Here, the TDG subgraph 1120 models the techniques 1130, 1150, and 1170 to be linked together along with detectors 1140, 1160, and 1180. In this case the probability of seeing one technique in the environment depends on whether the other techniques have been observed, as well as on knowing whether any of the techniques have appeared. This dependency is captured by the fully connected acyclic graph 1100 as shown. For example, the probability of seeing technique C changes depending on whether technique A and technique B are observed, as well as on knowing whether any of the techniques has appeared. This is why technique C has as parents technique A, technique B, and node 1115.

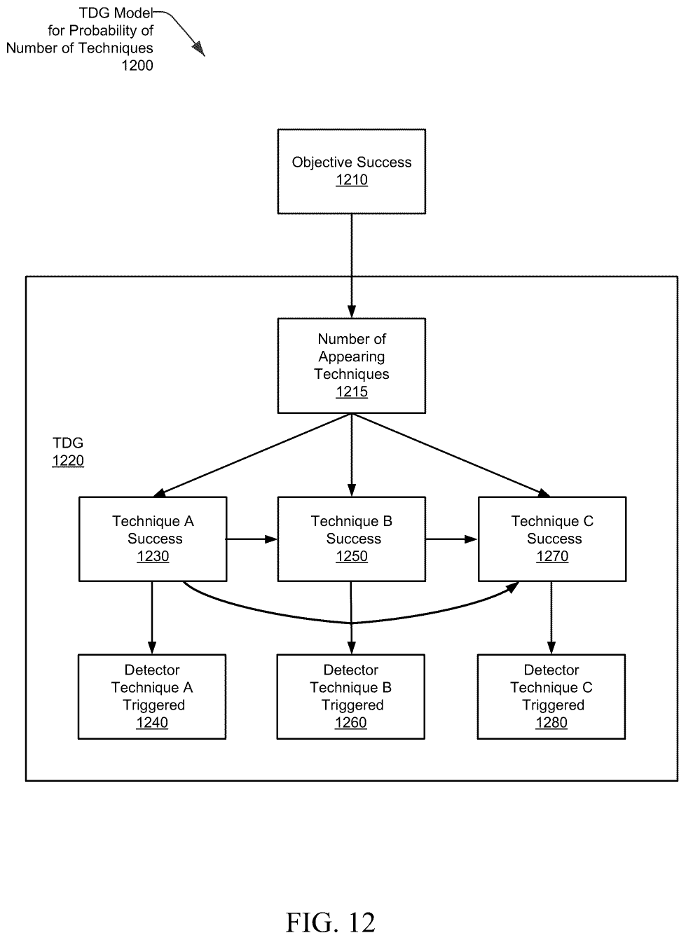

The TDG model 1200, illustrated in FIG. 12, may be used to describe the case where techniques are equiprobable and the likelihood of the number of techniques appearing together each time 1215 is modelled. This type of modelling is useful for cases when more than one technique may appear together, but the probability of seeing a certain number of techniques together decreases as the number of techniques increases. For example, techniques associated with the execution objective 910, the persistence objective 920, and the exfiltration objective 960 can be modelled in this way. Here, the TDG subgraph 1220 models the techniques 1230, 1250, and 1270 to be linked together along with detectors 1240, 1260, and 1280. In this case the probability of seeing one technique in the environment depends on whether the other techniques have been observed, as well as on knowing how many techniques have appeared in the environment (which is captured by node 1215). This dependency is captured by the fully connected acyclic graph 1200 as shown. For example, the probability of seeing technique C changes depending on whether technique A and technique B are observed, as well as on knowing the number of techniques that have appeared. This is why technique C has as parents technique A, technique B, and node 1215.

Turning now to FIG. 6 and a process 600 illustrated therein for instantiating the Bayesian network architecture, at operation 610, objectives are identified for inclusion in levels 1, 2, or 3 of the network architecture 425, based on whether they are a first step objective, an intermediate objective, or an end goal objective, as described above. These objectives may include the objectives shown in FIG. 9 as well as any other suitable objectives.

At operation 620, for each objective, the associated technique or techniques are identified, for example based on expert knowledge or a database of techniques. Each technique is associated with a detector.

At operation 630, a suitable TDG is chosen for each objective according to the type of dependencies (e.g., independent, one technique, equiprobable techniques) between the techniques associated with the objective, as described above. The TDG of the chosen type is included in the network architecture 425.

At operation 640, user property detectors are identified, for example based on expert knowledge or a database of available detectors, and included in the network architecture 425.

At operation 650, the nodes associated with the user property detectors, the objectives, and the TDGs are connected as illustrated in FIG. 9, and described above.

FIG. 7 is a flow diagram of a process for calculating conditional probabilities, executed by the CPT calculator 450, or the sub-components thereof, in accordance with an example of the present disclosure.

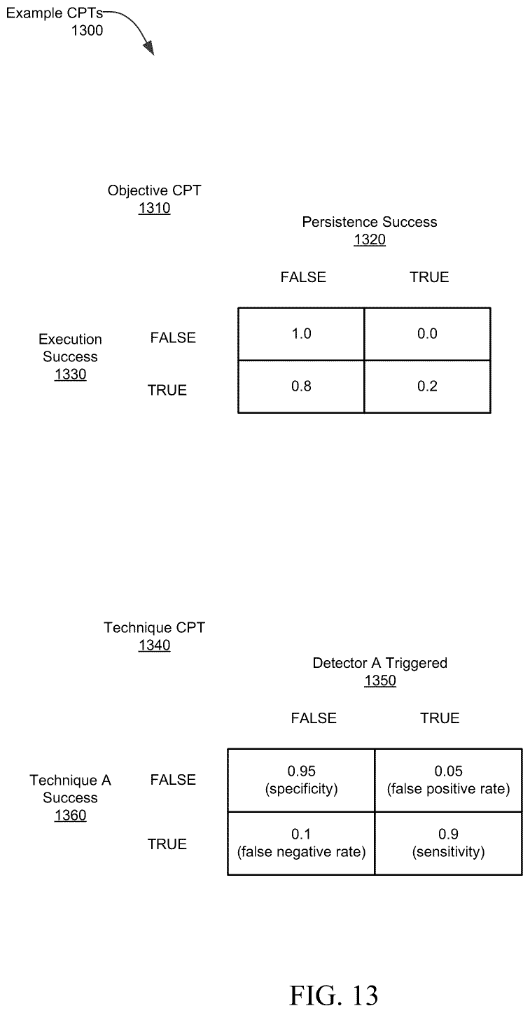

The process will be described with reference to the example CPTs 1300, shown in FIG. 13, in accordance with an example of the present disclosure. Each node in the network architecture 425 has an associated CPT. The CPTs store the conditional probabilities of the random variables associated with a node, given the values of the random variables associated with one or more parent nodes. For example, an objective CPT 1310 is shown for the persistence objective. The table has true and false entries for persistence success 1320 and the parent execution success 1330. In this example, as shown in the top row, the probability of persistence objective failure given that the parent execution success does not appear is 1.0 (i.e., 100 percent), and consequently the probability of persistence objective success under this condition is 0.0. However, as shown in the bottom row, the probability of persistence objective failure given that execution success does appear is 0.8, and consequently the probability of persistence objective success given this condition is 0.2.

As another example, a technique CPT 1340 is shown for a detector (labeled detector A). The table has true and false entries for detector A triggered 1350 and the parent technique A success 1360. In this example, as shown in the top row, the probability of detector A not being triggered given that parent technique A fails is 0.95. This is referred to as the specificity of the detector. Consequently, the probability of detector A being triggered given that parent technique A fails is 0.05 (e.g., 1—the specificity, also referred to as the false positive rate FPR or false alarm rate). However, as shown in the bottom row, the probability of detector A not being triggered given that parent technique A succeeds is 0.1. This is referred to as the false negative rate of the detector. Consequently, the probability of detector A being triggered given that parent technique A succeeds is 0.9. This referred to as the sensitivity of the detector or probability of detection. The sensitivity is equal to 1—the false negative rate.

The values in the CPTs, for objectives and techniques, may be provided through expert knowledge (e.g., based on the experience of security experts) or through experimentation. In the case of expert knowledge, the expert specifies: (1) the likelihood that one objective appears in the environment given the appearance of the parent objective; and (2) the likelihood that certain techniques associated with the objective appear given that the objective has successfully been achieved in the environment. These probabilities are inherently related to the nature of the problem of combining multiple indicators for threat detection. Some of these probabilities can also be estimated by referencing cybersecurity related knowledge databases that include known procedures of attacks.

In the case of data driven experimentation, these probabilities may be estimated based on data resulting from attacks (usually simulated) and from normal traffic. More specifically, the sensitivity of each detector is estimated using a representative playbook of instances of the corresponding technique and counting the proportion of instances in the playbook which are successfully detected. The specificity of each detector is computed using a representative set of normal traffic examples and counting the proportion of instances which are successfully recognized as normal.

Turning now to FIG. 7 and the process 700 illustrated therein for calculating conditional probabilities, at operation 710, for each objective, the probability of that objective appearing, given the parent objectives, is estimated based on expert knowledge or through experimentation, as described above.

At operation 720, the objective nodes of the CPTs are populated with the objective probabilities provided in the operation 710.

At operation 730, for each technique, the probability of that technique appearing, given the parent nodes, is also estimated based on expert knowledge or through experimentation, as described above.

At operation 740, the probability of a number of appearing techniques is estimated for TDG types 1100 and 1200, given the success of the associated objective, again based on expert knowledge or through experimentation, as described above.

At operation 750, the CPTs of the techniques and the number of appearing techniques in the TDGs are populated with the probabilities estimated in the operations 730 and 740.

At operation 760, the process loops back to operations 710 and 730 for reassessment as needed, as described further below.

At operation 770, the sensitivity of the detectors is calculated based on a playbook of attacks, as described above, or through any other suitable mechanism.

At operation 780, the specificity of the detectors is calculated based on normal traffic, as described above, or through any other suitable mechanism.

At operation 790, the CPTs of the detector nodes are populated with the sensitivity and specificity estimated in the operations 770 and 780

At operation 795, the process loops back to operation 770 for reassessment as needed, as described below.

The values of the CPTs may be updated (e.g., reassessment) when new knowledge or data is available about the associated probabilities. New knowledge may be available when security experts reassess their beliefs about the dependencies between objectives and techniques in the network. New data may also become available in the form of new examples of attacks or of normal traffic, which can be used to update the sensitivity and specificity estimates of the network detectors. Additionally, when the detectors are updated (e.g., their logic or parameters change to be able to detect new variants of the techniques) their sensitivity and specificity may need to be re-estimated, so the associated CPTs are updated accordingly. And when new threat detectors become available (or existing threat detectors are removed, for example through obsolescence or for other reasons), nodes associated with those detectors can be added (or removed) from the network. In some examples, new threat detectors may be provisioned by users (e.g., at the device level) or by IT administrators (e.g., at any level: device, network, server, etc.) as such detectors become available in the market or through internal development by a cyber-security department.

FIG. 8 is a flow diagram of a process for calculating detection thresholds, executed by the detection thresholds calculator 460, or the sub-components thereof, in accordance with an example of the present disclosure.

In some examples, two detection thresholds are calculated, as described below, for subsequent use in the integrated threat detector to generate alerts and categorize users as high, medium, or low risk (although additional thresholds may be employed to expand the number of categories).

Since the Bayesian Network describes the cybersecurity related activity in the IT environment, it can be used to generate examples of detections, which follow the expected distribution in a real environment. At operation 810, a relatively large number N of examples of activity (e.g., N equal 10000 or more) are generated given that a user is malicious (i.e., setting node 900 to one). At operation 820, another N examples of activity are generated given that the user is legitimate (i.e., setting node 900 to zero). Each example is generated by forward sampling the Bayesian network 240 to produce a value for each detector node in the network. Using the values of the detector nodes in each example, an observation vector of length N for a malicious user and an observation vector of length N for a legitimate user is generated, each vector comprising the values for the detector nodes in the network that correspond to one instance of activity.

At operation 830, for each produced observation vector, the Bayesian network is used to compute the posterior probability of the user being malicious (i.e., the posterior probability of the random variable associated with node 900). This posterior probability serves as a decision score for each example of user activity. Each example is labeled with ground truth since it is known whether it corresponds to malicious or legitimate activity (e.g., generated in operation 810 or 820).

At operation 840, a decision threshold is varied across the range of the produced scores of the examples. For each value of the decision threshold, an inference is made for each example as follows. The example is classified as malicious if the score is above the threshold, otherwise it is classified as legitimate. These classifications, based on the score of the model, are compared with the ground truth labels of each example. In this way, a TPR (e.g., sensitivity) and an FPR (e.g., 1—specificity) is computed for each value of the decision threshold.

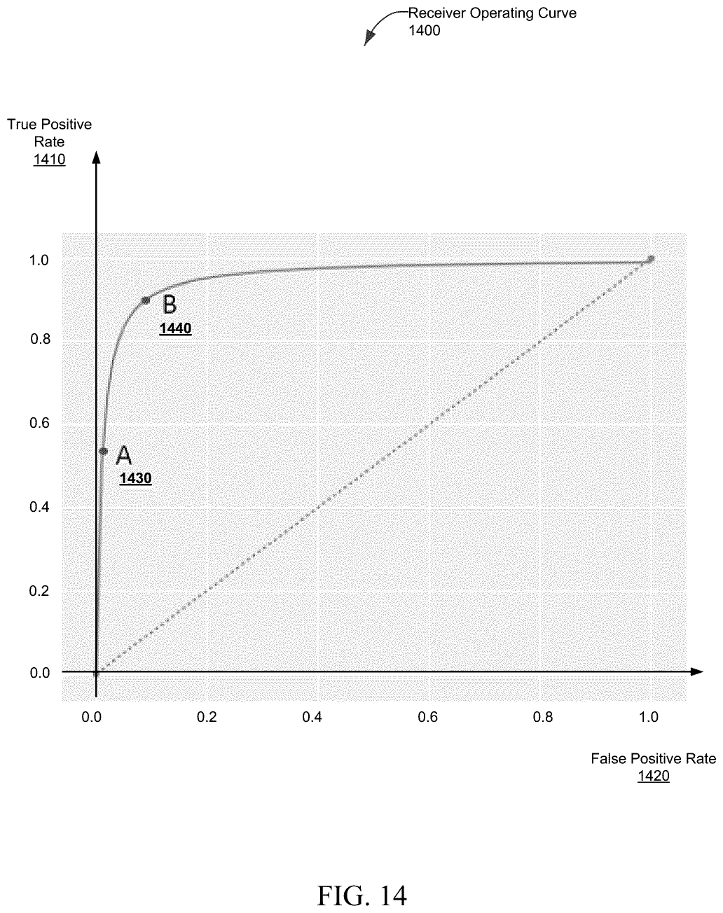

At operation 850, an ROC curve is generated based on the TPR and FPR. FIG. 14 illustrates an ROC curve 1400, in accordance with an example of the present disclosure. The ROC curve provides a point on the FPR axis 1420 and the TPR axis 1410 for each decision threshold value. The ROC curve illustrates the discriminating capability of the overall decision mechanism of the system. The better the performance of the individual detectors, the closer the area under the ROC curve will be to one (e.g., the curve will have a sharper knee).

At operation 860, two operating points, threshold A 1430 and threshold B 1440 are chosen based on a desired trade-off between sensitivity and specificity of the decision mechanism. In some examples, the trade-off decision may be made by an IT administrator (or other personnel tasked with making risk assessment and risk tolerance decisions), for example, through a UI of the analytics server 160. Point A is associated with a low FPR (approximately 0.05 in this example) and therefore a high specificity. Examples with a score higher than threshold A can be classified as relatively high risk (as in operation 540 of FIG. 5), since only a small portion of legitimate examples will fall in this range. Threshold B has a larger FPR (approximately 0.12 in this example) and therefore a medium specificity. Examples with a score falling between threshold A and threshold B (as in operation 560 of FIG. 5), can be classified as medium risk. All other examples with a score smaller than threshold B can be classified as relatively low risk.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

### Computing Platform for Threat Detector Integration

FIG. 15 is a block diagram of a computing platform 1500 configured to perform threat detector integration, in accordance with an example of the present disclosure. In some cases, the platform 1500 is the analytic server 160, of FIG. 1, which may be a workstation, server, laptop or other suitable computing device.

The computing platform 1500 includes one or more processors 1510, volatile memory 1520 (e.g., random access memory (RAM)), non-volatile memory 1530, one or more network or communication interfaces 1540, UI 1560, display element (e.g., screen) 1570, and a communications bus 1550. The computing platform 1500 may also be referred to as a computer or a computer system.

The non-volatile (non-transitory) memory 1530 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 1560 can include one or more input/output (I/O) devices (e.g., a mouse, a keyboard, a microphone, one or more speakers, one or more biometric scanners, one or more environmental sensors, and one or more accelerometers, etc.).

The display element 1570, can provide a graphical user interface (GUI) and in some cases, may be a touchscreen or any other suitable display device.

The non-volatile memory 1530 stores an operating system 1532, one or more applications 1534, and data 1536. The applications may include the threat detector integration system 170 such that, for example, computer instructions of the operating system 1532 and applications 1534 are executed by processor(s) 1510 out of the volatile memory 1520. In some examples, the volatile memory 1520 can include one or more types of RAM and/or a cache memory that can offer a faster response time than a main memory. Data can be entered through the user interface 1560. Various elements of the computer 1500 can communicate via the communications bus 1550.

The illustrated computing platform 1500 is shown merely as an example client device or server and can be implemented by any computing or processing environment with any type of machine or set of machines that can have suitable hardware and/or software capable of operating as described herein.

The processor(s) 1510 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 1510 can be analog, digital, or mixed. In some examples, the processor 1510 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 1540 can include one or more interfaces to enable the computing platform 1500 to access a computer network 1580 such as a Local Area Network (LAN), a Wide Area Network (WAN), a Personal Area Network (PAN), or the Internet through a variety of wired and/or wireless connections, including cellular connections. In some examples, the network 1580 may allow for communication with other computing platforms 1590, to enable distributed computing.

In described examples, the computing platform 1500 can execute an application on behalf of a user of the client device. For example, the computing platform 1500 can execute one or more virtual machines managed by a hypervisor. Each virtual machine can provide an execution session within which applications execute on behalf of a user or a client device, such as a hosted desktop session. The computing platform 1500 can also execute a terminal services session to provide a hosted desktop environment. The computing platform 1500 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory; and
at least one processor coupled to the memory and configured to:
detect triggering of one or more threat detectors;
activate a subset of nodes from a plurality of nodes in a Bayesian network in response to the detection, the activated subset of nodes associated with the triggered threat detectors;
calculate a probability of malicious action using the Bayesian network to combine probabilities associated with the activated subset of nodes;
determine that the probability exceeds a threshold value; and
perform a security action in response to the determination.

2. The computer system of claim 1, wherein each node of the plurality of nodes of the Bayesian network is configured to provide a probability of detection and a probability of false alarm of the threat associated with the each node.

3. The computer system of claim 2, wherein the each node is associated with a threat objective and with one or more threat techniques, the threat techniques associated with the threat objective and with one of the threat detectors.

4. The computer system of claim 1, wherein the Bayesian network includes a node associated with a user property detector, the user property detector configured to detect properties of the user associated with malicious action, and the at least one processor is further configured to calculate a probability of malicious action using the Bayesian network to combine probabilities associated with the activated subset of nodes and the node associated with the user property detector.

5. The computer system of claim 4, wherein the properties include a geolocation of the user and reputation data associated with an internet provider employed by the user.

6. The computer system of claim 1, wherein the at least one processor is further configured to select the threshold value based on a tradeoff between a probability of detection of the malicious action and a probability of false alarm of the malicious action.

7. The computer system of claim 1, wherein the at least one processor is further configured to create and update the plurality of nodes of the Bayesian network based on provisioning of threat detectors and provisioning of threat detector performance data.

8. A method for combining threat detections:
detecting, by a computer system, triggering of one or more threat detectors;
activating, by the computer system, a subset of nodes from a plurality of nodes in a Bayesian network in response to the detection, the activated subset of nodes associated with the triggered threat detectors;
calculating, by the computer system, a probability of malicious action using the Bayesian network to combine probabilities associated with the activated subset of nodes;
determining, by the computer system, that the probability exceeds a threshold value; and
performing, by the computer system, a security action in response to the determination.

9. The method of claim 8, wherein each node of the plurality of nodes of the Bayesian network is configured to provide a probability of detection and a probability of false alarm of the threat associated with the each node.

10. The method of claim 9, wherein the each node is associated with a threat objective and with one or more threat techniques, the threat techniques associated with the threat objective and with one of the threat detectors.

11. The method of claim 8, wherein the Bayesian network includes a node associated with a user property detector, the user property detector configured to detect properties of the user associated with malicious action, and the method further comprising calculating a probability of malicious action using the Bayesian network to combine probabilities associated with the activated subset of nodes and the node associated with the user property detector.

12. The method of claim 11, wherein the properties include a geolocation of the user and reputation data associated with an internet provider employed by the user.

13. The method of claim 8, further comprising selecting the threshold value based on a tradeoff between a probability of detection of the malicious action and a probability of false alarm of the malicious action.

14. The method of claim 8, further comprising creating and updating the plurality of nodes of the Bayesian network based on provisioning of threat detectors and provisioning of threat detector performance data.

15. A non-transitory computer readable medium storing executable sequences of instructions to combine threat detections, the sequences of instructions comprising instructions to:
detect triggering of one or more threat detectors;
activate a subset of nodes from a plurality of nodes in a Bayesian network in response to the detection, the activated subset of nodes associated with the triggered threat detectors;
calculate a probability of malicious action using the Bayesian network to combine probabilities associated with the activated subset of nodes;
determine that the probability exceeds a threshold value; and
perform a security action in response to the determination.

16. The computer readable medium of claim 15, wherein each node of the plurality of nodes of the Bayesian network is configured to provide a probability of detection and a probability of false alarm of the threat associated with the each node.

17. The computer readable medium of claim 16, wherein the each node is associated with a threat objective and with one or more threat techniques, the threat techniques associated with the threat objective and with one of the threat detectors.

18. The computer readable medium of claim 15, wherein the Bayesian network includes a node associated with a user property detector, the user property detector configured to detect properties of the user associated with malicious action, and the sequences of instructions further include instructions to calculate a probability of malicious action using the Bayesian network to combine probabilities associated with the activated subset of nodes and the node associated with the user property detector.

19. The computer readable medium of claim 18, wherein the properties include a geolocation of the user and reputation data associated with an internet provider employed by the user.

20. The computer readable medium of claim 15, wherein the sequences of instructions further include instructions to select the threshold value based on a tradeoff between a probability of detection of the malicious action and a probability of false alarm of the malicious action.

21. The computer readable medium of claim 15, wherein the sequences of instructions further include instructions to create and update the plurality of nodes of the Bayesian network based on provisioning of threat detectors and provisioning of threat detector performance data.
